(19) United States
(12) Patent Application Publication
(10) Pub. No.: US 2010/0262764 A1
(43) Pub. Date: Oct. 14, 2010

(54) METHOD FOR ACCESSING STORAGE APPARATUS AND RELATED CONTROL CIRCUIT

(76) Inventors: Chao-Yin Liu, Hsinchu City (TW); Sheng-Hsuan Wang, Changhua County (TW)

Correspondence Address: NORTH AMERICA INTELLECTUAL PROPERTY CORPORATION, P.O. BOX 506, MERRIFIELD, VA, 22116, US

(21) Appl. No.: 12/641,330

(22) Filed: Dec. 18, 2009

(30) Foreign Application Priority Data
Apr. 14, 2009 (TW) 098112304

(51) Int. Cl. G06F 12/00

(52) U.S. Cl. 711/103; 711/154; 711/E12.001

(57) ABSTRACT

A storage apparatus includes a first storage unit and at least a second storage unit. A method for accessing the storage apparatus generates a plurality of bad block lists regarding the plurality of the storage units, respectively, and according to at least one bad block indicated by a bad block list of the first storage unit, configures at least a good block in each second storage unit corresponding to the at least one bad block of the first storage unit as a replacement block of each second storage unit. Accordingly, the method generates a mapping result of each second storage unit according to a bad block list of the second storage unit and each replacement block, and accesses the storage apparatus according to the bad block list of the first storage unit and each mapping result.

### BACKGROUND OF THE INVENTION

1. Field of the Invention

The present invention relates to bad block management, and more particularly, to a method and a related circuit utilized in a storage apparatus having a plurality of flash memories (e.g. a multi-channel solid state drive) for the purpose of bad block management.

2. Description of the Prior Art

Storage apparatus composed of flash memories are widely used in embedded systems and portable electronic devices. As storage apparatus of larger capacity and higher efficiency has become a requirement, the flash memory apparatus has been developed. In recent times, flash memory apparatus have started to replace conventional storage apparatus (e.g. hard disks). One such flash memory apparatus is the solid state drive (SSD), which is a mass storage apparatus composed of flash memories, and is positioned to replace the traditional hard disk.

Compared with maturely-developed traditional hard disks, however, flash memories still have many shortcomings that need to be overcome, one of which is an unsatisfactory read/write speed. In order to improve read/write speed, designers have introduced redundancy array techniques into the SSD, wherein data striping is one technique utilized for increasing data access speed. By disposing several flash memories in a single SSD to form several corresponding access channels, these flash memories can be accessed simultaneously, thereby increasing data access speed. However, during the fabrication or the actual operation of the flash memory, the flash memory cell may be broken. Since an erase operation upon the flash memory must be performed by blocks, a broken flash memory cell will mean the whole block cannot work normally.

The control circuit of the flash memory has the capability of performing bad block management to avoid data access to these bad blocks. Among conventional bad block management methods, the simplest one is the skip block method. In the skip block method, when a target address of the data to be stored refers to an address of a bad block, the data will be stored into a next good block near to the bad block, thereby skipping the bad block. However, there are correspondences between different access channels (and therefore between different flash memories) in a multi-channel SSD. If one block in a certain flash memory is skipped, the skip block method will skip all the corresponding blocks in other flash memories, which wastes the storage space of the multi-channel SSD. Thus, the skip block method is not very economical for the multi-channel SSD.

In addition to the skip block method, there is a method of bad block management that collects location information of bad blocks (e.g. the address of the bad block). According to location information, writing/reading data upon these existing bad blocks can be avoided by replacing the bad blocks with good blocks. More specifically, the addresses of the bad blocks will respectively be remapped to the addresses of the good blocks, which is referred to as block replacement, and the corresponding remapping results are recorded in the control circuit of the SSD. Once the control circuit is asked to write/read data upon these bad blocks, the control circuit turns to writing/reading data upon the corresponding replacement blocks according to the remapping results. There are two ways of acquiring the replacement blocks. One way is to select a good block as a replacement block using algorithms. Thus, each flash memory of different channels in the SSD will have its own remapping result, and the control circuit accesses each flash memory according to the corresponding remapping result. However, this method causes an overhead of the control circuit. Moreover, the control circuit needs to replace the bad block with the replacement block one by one according to remapping results, which could cause severe latency. The other way is to configure reserved blocks as the replacement block in the same flash memory. However, this method inevitably increases the fabrication costs of the flash memory since these additional reserved blocks cannot be utilized for data storage.

Therefore, the conventional bad block management method still has many inherent shortcomings that need to be overcome.

### SUMMARY OF THE INVENTION

With this in mind, it is one objective of the present invention to overcome the conventional bad block management method problem of low efficiency for a multi-channel SSD. The present invention provides an innovative bad block management method and a related control circuit to overcome the problems encountered by the conventional method.

According to one exemplary embodiment of the present invention, a method for accessing a storage apparatus is provided. The storage apparatus has a plurality of storage units respectively corresponding to a plurality of access channels, wherein each storage unit respectively has a plurality of blocks and the plurality of access channels operate simultaneously in a data access operation. In addition, the plurality of storage units includes a first storage unit and at least one second storage unit. The method comprises: generating a plurality of bad block lists respectively corresponding to the plurality of storage units according to bad blocks that cannot operate normally in the plurality of storage units; according to at least one bad block indicated by a bad block list of the first storage unit, configuring a good block that corresponds to the bad block and can operate normally in each second storage unit as a replacement block; generating a corresponding mapping result according to a bad block list and each replacement block of each second storage unit; and accessing the storage apparatus according to the bad block list of the first storage unit and the mapping result of each second storage unit.

According to another exemplary embodiment of the present invention, a control circuit for accessing a storage apparatus is provided. The storage apparatus has a plurality of storage units respectively corresponding to a plurality of access channels, wherein each storage unit respectively has a plurality of blocks, and the plurality of access channels operate simultaneously in a data access operation. In addition, the plurality of storage units includes a first storage unit and at least one second storage unit. The control circuit comprises: a processing unit, a storing unit and a plurality of mapping units. The processing unit is for generating a plurality of bad block lists respectively corresponding to the plurality of storage units according to bad blocks that cannot operate normally in the plurality of storage units. Furthermore, according to at least one bad block indicated by a bad block list of the first storage unit, the processing unit configures a good block that corresponds to the bad block and can operate normally in each second storage unit as a replacement block and generates a corresponding mapping result according to a bad block list and each replacement block of each second storage unit. The storing unit is coupled to the processing unit and is utilized for storing the bad block lists. The plurality of mapping units are respectively coupled to the processing unit and the plurality of storage units and are respectively configured by the plurality of corresponding mapping results, wherein the control circuit accesses the plurality of storage units through the plurality of mapping units and the bad block list of the first storage unit.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram showing an implementation of the method of the present invention.

FIG. 2 is a diagram of a mapping unit according to one exemplary embodiment of the present invention.

FIG. 3 is a flow chart according to one exemplary embodiment of the present invention.

FIG. 4 is an exemplary block diagram showing a control circuit of the present invention and an SSD using the control circuit.

### DETAILED DESCRIPTION

Certain terms are used throughout the following description and claims to refer to particular system components. As one skilled in the art will appreciate, manufacturers may refer to a component by different names. This document does not intend to distinguish between components that differ in name but not differ in functionality. In the following discussion and in the claims, the terms “include”, “including”, “comprise”, and “comprising” are used in an open-ended fashion, and thus should be interpreted to mean “including, but not limited to . . . ” The terms “couple” and “coupled” are intended to mean either an indirect or a direct electrical connection. Thus, if a first device couples to a second device, that connection may be through a direct electrical connection, or through an indirect electrical connection via other devices and connections.

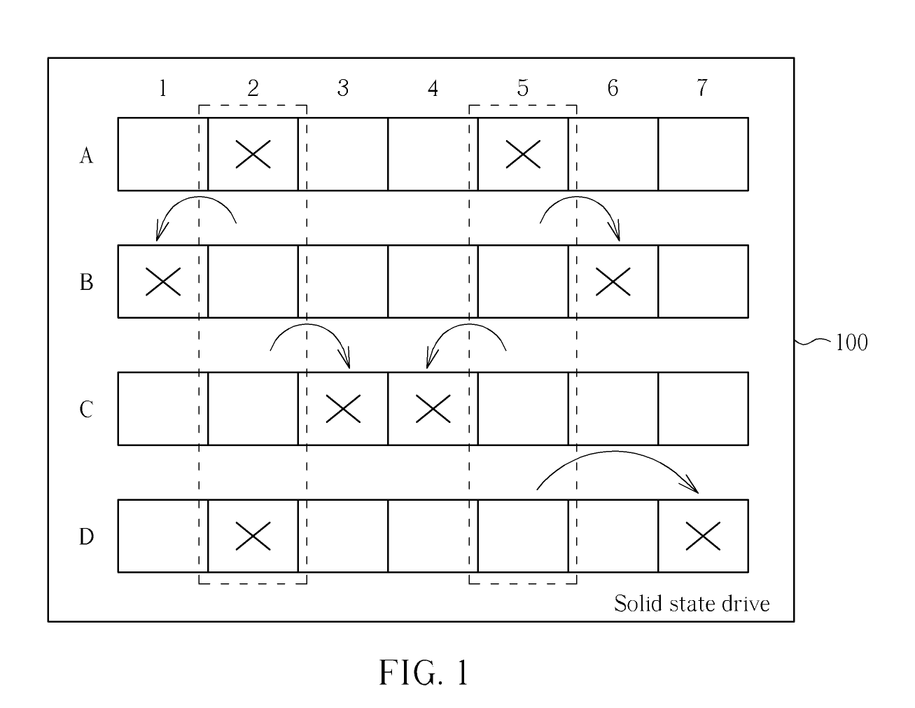

Please refer to FIG. 1, which is a diagram illustrating an exemplary embodiment of the method of the present invention. As shown in FIG. 1, a multi-channel SSD 100 is a storage apparatus having four access channels and consists of four flash memories A, B, C and D respectively corresponding to four access channels. Each of the flash memories A, B, C and D respectively has seven blocks, numbered as shown in FIG. 1, where the symbol “X” is meant to indicate the bad block. One technical feature of the present invention is making a bad block state of the flash memory a criterion for generating mapping results of other flash memories in the multi-channel SSD. For illustrative purposes, the bad block state of the flash memory A is used as a criterion in the following. It should be noted that using one of flash memories B, C, and D as a criterion to generate the mapping result is also feasible. Furthermore, there is no limitation in the number of access channels used in the SSD. In other words, the method of the present invention can apply to the SSD having any number of access channels. Moreover, those skilled in the art should be able to readily observe numerous modifications and alterations of devices and method while retaining the teachings of the invention. Accordingly, the above disclosure should be construed as limited only by the metes and bounds of the appended claims. For example the present invention can further be applied to any storage system consisting of redundant arrays based on the concept of the present invention.

When utilizing bad blocks of flash memory A as a criterion for generating the mapping result of other flash memories, the bad blocks 2 and 5 in the flash memory A are employed as bases, and the corresponding blocks 2 and the corresponding blocks 5 in the other flash memories B, C, and D respectively serve as replacement blocks in each flash memory for replacing the bad blocks in flash memories B, C, and D. In flash memory B, the block 2 is originally a good block, and therefore serves as a replacement block for the bad block 1 of the flash memory B. Also, the good block 5 is utilized as a replacement block for the bad block 6. Similarly, in the flash memory C, the good block 2 is utilized as a replacement block for the bad block 3 and the good block 5 is utilized as a replacement block for the bad block 4. In flash memory D, the block 2 is originally a bad block, so it is not able to be utilized as a replacement block. The good block 5 is utilized as a replacement block for the bad block 7 in the flash memory D. Via these replacements, addresses of the bad blocks are mapped to addresses of the replacement blocks so as to generate a mapping result of each flash memory. Thus, it is not necessary to skip the good blocks 2 and 5 in the flash memory B, C, and D, and these good blocks 2 and 5 can used to replace the bad blocks in respective flash memories B, C and D, thereby avoiding the fact that good blocks are wasted in the skip block method. It should be carefully noted that, in each flash memory, which bad block a replacement block replaces is not a limitation of the present invention, and the above case is just for illustrative purposes.

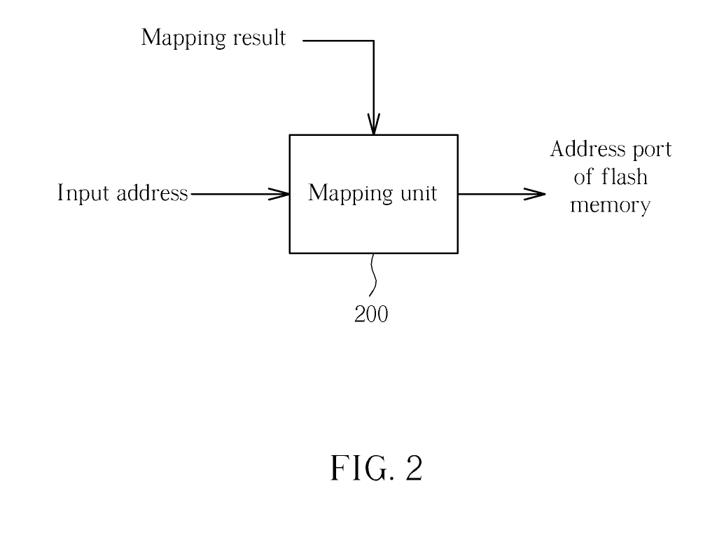

All of the blocks 2 and the blocks 5 in flash memories A, B, C, and D cannot be directly accessed anymore after introducing the method of the present invention but other blocks are still available for data storage. In order to solve the problem that too many mapping results greatly increases the overhead of the control circuit, the present invention further employs a mapping unit for performing address mapping for each flash memory. Please refer to FIG. 2. A mapping unit 200 is a hardware mapping machine, and is designed to perform a hardwired mapping.

During the initialization, the mapping unit 200 is configured according to a mapping result. Then, if an inputting address corresponding to a bad block is input into the mapping unit 200, the mapping unit 200 will transform the inputting address to an address of a replacement block according to the mapping result, and transmits the address of the replacement block into an address port of the flash memory, finishing the address mapping. Please note that if the inputting address indicates a good block, the inputting address will be bypassed to the address port of the flash memory. Obviously, the mapping unit can reduce the overhead of the control circuit. Moreover, even though the mapping unit is disposed inside the control unit in this embodiment, any modification that utilizes the mapping unit and disposes the mapping unit outside the control circuit should also fall within the scope of the present invention.

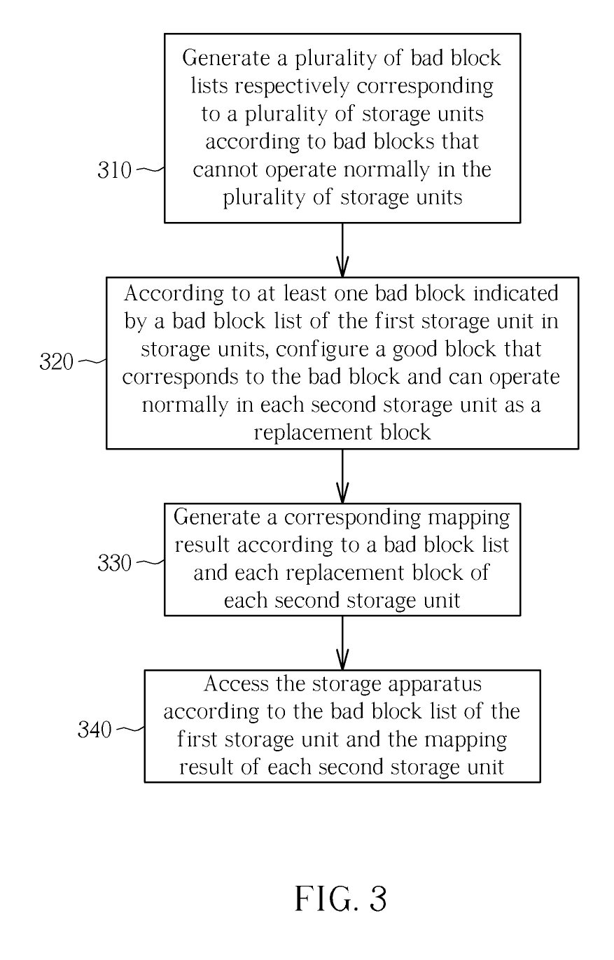

Based on the foregoing embodiment, the method of the present invention can be further summarized as steps 310-340 illustrated in FIG. 3. The steps of the method comprise: generating a plurality of bad block lists respectively corresponding to a plurality of storage units of a storage apparatus according to bad blocks that cannot operate normally in the plurality of storage units; according to at least one bad block indicated by a bad block list of a first storage unit of the storage apparatus, configuring a good block that corresponds to the bad block and can operate normally in each second storage unit as a replacement block; generating a corresponding mapping result according to a bad block list and each replacement block of each second storage unit; and accessing the storage apparatus according to the bad block list of the first storage unit and the mapping result of each second storage unit.

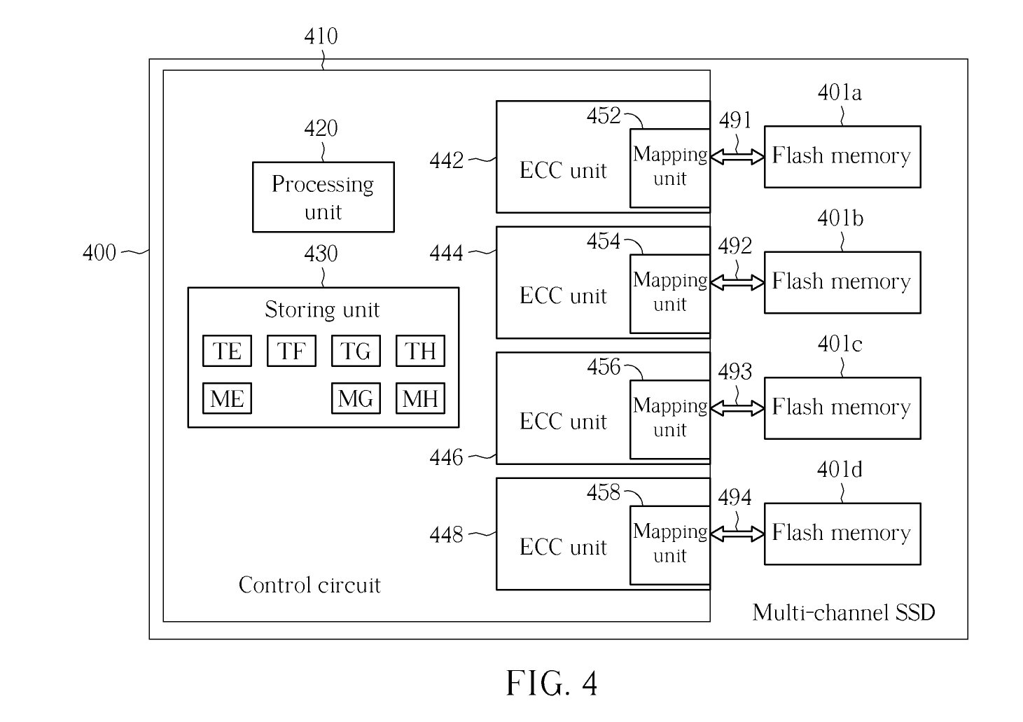

According to the spirit and concept provided by the method of the present invention, a control circuit which can be disposed in a flash memory apparatus (e.g. a multi-channel SSD) and performs a bad block management upon the flash memory apparatus is further provided in accordance with the above-mentioned method. Please refer to FIG. 4, which is an exemplary diagram showing a control unit of the present invention disposed in a multi-channel SSD. As shown in FIG. 4, a control circuit 410 is disposed in a multi-channel SSD 400 and is employed for accessing flash memories 401a, 401b, 401c, and 401d in the multi-channel SSD 400 through a plurality of access channels 491-494.

In addition, the control circuit 410 comprises a processing unit 420, a storing unit 430, and a plurality of error code correction (ECC) units 442, 444, 446, and 448. A plurality of mapping units 452, 454, 456, and 458 are respectively disposed in the plurality of ECC units 442, 444, 446, and 448. Basically, any write/read operation to/from the flash memories 401a, 401b, 401c, and 401d must be processed through the ECC units in advance. Thus, in this embodiment, the mapping units 452, 454, 456, and 458 are respectively incorporated into the ECC unit 442, 444, 446, and 448. However, the mapping units 452, 454, 456, and 458 could be disposed in other circuit blocks inside the control circuit 410 or outside the control unit 410 in other embodiments of the present invention. The functions and operations of the mapping unit 452, 454, 456, and 458 have already been explained in the above, so further description is omitted here for the sake of brevity.

During the initialization of the multi-channel SSD 400, the processing unit 420 respectively checks whether each block in flash memories 401a, 401b, 401c and 401d is able to work normally in order to generate bad block lists TE, TF, TG, and TH respectively corresponding to flash memories 401a, 401b, 401c and 401d. Bad blocks could exist in the flash memories 401a [symbol] 401b [symbol] 401c and 401d after fabrication. Therefore, a specific position in each block is programmed to a value different from “0xff” by the manufacturer if the block is a bad block. Moreover, during the actual operation, a good block could be broken, so the processing unit 420 also marks these newly generated bad blocks by the value different from “0xff”. Thus, each block is checked to determine whether or not it is a bad block by the processing unit 420 for generating the bad block lists TE, TF, TG, and TH or the processing unit 420 loads the generated bad block lists TE, TF, TG, and TH from the flash memories 401a, 401b, 401c and 401d, and then stores the bad block lists TE, TF, TG, and TH into storing unit 430. The processing unit 420 selects one of the flash memories 401a, 401b, 401c and 401d according to the bad block lists TE, TF, TG, and TH and uses the bad block state of the selected one as a criterion to generate the mapping result. In the following part, the bad block state of the flash memory 401b is employed as the criterion for illustrative purposes.

Accordingly, the processing unit 420 finds out all bad block(s) listed in the bad block list TF, and configures good block(s) of the flash memories 401a, 401c, and 401d corresponding to the bad block(s) of the flash memory 401b as replacement blocks in each flash memories 401a, 401c, and 401d. Please note that the correspondences between flash memories 401a, 401b, 401c and 401d result from the data striping technique used in the multi-channel SSD 400. In addition if the corresponding block in flash memories 401a, 401c, and 401d is a bad block, it will not be utilized as a replacement block. After the processing unit 420 respectively determines the replacement blocks in flash memories 401a, 401c, and 401d according to the criterion (bad block state of the flash memory 401b) by referencing the bad block list TF, the processing unit 420 generates the corresponding mapping results ME, MG and MH according to the bad block lists TE, TG, and TH and each replacement block. The mapping results map the addresses of the bad blocks to the addresses of the replacement blocks. The mapping result could be stored in the storing unit 430 as a mapping table. Hence, without departing from the concept of the present invention, it is also feasible that the address mapping is directly performed by the processing unit 420 through loading the mapping table in the storing unit 430. In this embodiment, the mapping units 452, 454, 456, and 458 perform the address mapping between the bad block and the replacement block by a hardwired mapping means. However, this is not meant to be a limitation, and any other hardware means to achieve the address mapping also falls within the scope of the present invention.

In short, all the replacement blocks in a flash memory are respectively mapped to all the existing bad blocks in this flash memory so as to generate a mapping result of this flash memory. Consequently, the processing unit 420 respectively configures the mapping units 452, 456, and 458 in accordance with the mapping result ME, MG, and MH so that the following data access operation will be able to avoid being performed upon those existing bad blocks. With the help of the mapping units, data is stored into the corresponding replacement blocks instead. In this embodiment, the processing unit 420 does not need to perform additional address translations between the replacement blocks and the bad blocks due to the existence of mapping units so that the computational loading of the processing unit 420 can be therefore reduced. Once mapping results are successfully generated, the data access to the SSD 400 is executed by the control circuit 410 with the bad block list TF stored in the storing unit 430 hereafter. For example, when writing data into the SSD 400, the control circuit 410 first receives a logic block address regarding the data to be written, and then generates a corresponding physical block address. The control circuit 410 determines whether the physical block address is feasible by referencing the bad block list TF (for example, as shown in FIG. 1, the physical block addresses regarding the block 2 and the block 5 are not feasible addresses.) If the physical block address is feasible, the physical block address will be assigned for the logical block address; otherwise, another physical block address will be assigned for the logical block address. Then, according to data striping, the data segments will be respectively written into the good blocks or replacement blocks in the flash memories 401a, 401b, 401c, and 401d. Hence, the processing unit 420 only needs to generates a specified physical block address according to the bad block list TF and when the mapping units 452, 456, and 458 receive the physical addresses, the mapping units 452, 456, and 458 perform address mapping operations in order to prevent the condition where data is written into the physical block address of the bad blocks. In data read operations, through relations between the physical block addresses and the logical block addresses, the data segments are respectively derived from the flash memories 401a, 401b, 401c, and 401d. As the mapping units 452, 456, and 458 wholly replace the bad blocks with the replacement blocks, the control circuit 410 does not need to consider about the bad blocks in the flash memories 401a, 401c and 401d and just needs to avoid assigning the logical block address to the physical block address of the bad block in the flash memory 401b for each data access operation.

Compared to the conventional methods, the present invention not only considerably reduces the loading of the processing unit but also avoids the waste of storage space in the flash memory. As the storage apparatus uses data striping, the present invention provides an excellent bad block management method and a related control circuit.

Those skilled in the art will readily observe that numerous modifications and alterations of the device and method may be made while retaining the teachings of the invention.

What is claimed is:

1. A method for accessing a storage apparatus, the storage apparatus having a plurality of storage units respectively corresponding to a plurality of access channels, each storage unit respectively having a plurality of blocks, the plurality of access channels operating simultaneously in a data access operation, the plurality of storage units including a first storage unit and at least one second storage unit, the method comprising:
generating a plurality of bad block lists respectively corresponding to the plurality of storage units according to bad blocks that cannot operate normally in the plurality of storage units;
according to at least one bad block indicated by a bad block list of the first storage unit, configuring a good block that corresponds to the bad block and can operate normally in each second storage unit as a replacement block;
generating a corresponding mapping result according to a bad block list and each replacement block of each second storage unit; and
accessing the storage apparatus according to the bad block list of the first storage unit and the mapping result of each second storage unit.

2. The method of claim 1, wherein the storage apparatus stores data into the plurality of storage units by means of data striping.

3. The method of claim 1, wherein the step of generating the corresponding mapping result according to the bad block list and each replacement block of each second storage unit comprises:
generating the corresponding mapping result by mapping an address of at least one bad block of each second storage unit to a replacement block of the same storage unit.

4. The method of claim 3, wherein the address of the bad block in each second storage unit is mapped to the address of the replacement block of the same storage unit by a hardwired mapping means.

5. The method of claim 1, wherein each storage unit is a non-volatile memory.

6. The method of claim 5, wherein each non-volatile memory is a flash memory.

7. The method of claim 1, wherein the storage apparatus is a multi-channel solid state drive.

8. A control circuit for accessing a storage apparatus, the storage apparatus having a plurality of storage units respectively corresponding to a plurality of access channels, each storage unit respectively having a plurality of blocks, the plurality of access channels operating simultaneously in a data access operation, the plurality of storage units including a first storage unit and at least one second storage unit, the control circuit comprising:
a processing unit, for generating a plurality of bad block lists respectively corresponding to the plurality of storage units according to bad blocks that cannot operate normally in the plurality of storage units; according to at least one bad block indicated by a bad block list of the first storage unit, for configuring a good block that corresponds to the bad block and can operate normally in each second storage unit as a replacement block; and for generating a corresponding mapping result according to a bad block list and each replacement block of each second storage unit;
a storing unit, coupled to the processing unit, for storing the bad block lists; and
a plurality of mapping units, respectively coupled to the processing unit and the plurality of storage units, respectively configured by the plurality of corresponding mapping results, wherein the control circuit accesses the plurality of storage units through the plurality of mapping units and the bad block list corresponding to the first storage unit.

9. The control circuit of claim 8, wherein the control circuit stores data into the plurality of storage units by means of data striping.

10. The control circuit of claim 8, wherein the control circuit generates the mapping result by mapping an address of at least one bad block of each second storage unit to a replacement block of the same storage unit.

11. The control circuit of claim 10, wherein the plurality of mapping units respectively map the address of the bad block of each second storage unit to the address of the replacement block of the same storage unit by a hardwired mapping means.

12. The control circuit of claim 8, wherein each storage unit is a non-volatile memory.

13. The control circuit of claim 12, wherein each non-volatile memory is a flash memory.

14. The control circuit of claim 8, wherein the storage apparatus controlled by the control circuit is a multi-channel solid state drive.
